(19) United States
(12) Patent Application Publication
(10) Pub. No.: US 2013/0118773 A1
(43) Pub. Date: May 16, 2013

(54) Z-AXIS CONDUCTIVE ARTICLE AND METHOD OF MAKING THE SAME

(71) Applicant: 3M INNOVATIVE PROPERTIES COMPANY, ST. PAUL, MN (US)

(72) Inventors: Junkang J. Liu, Woodbury, MN (US); Garry W. Lachmansingh, Plymouth, MN (US); Cecil V. Francis, Austin, TX (US); Rachel M. Lucking, Oakdale, MN (US); Stephen H. Larsen, Woodbury, MN (US); Badri Veeraraghavan, Woodbury, MN (US); Ali Berker, St. Paul, MN (US)

(73) Assignee: 3M INNOVATIVE PROPERTIES COMPANY, ST. PAUL, MN (US)

(21) Appl. No.: 13/650,987

(22) Filed: Oct. 12, 2012

Related U.S. Application Data
(60) Provisional application No. 61/558,611, filed on Nov. 11, 2011.

(51) Int. Cl. H01B 7/08; H01R 43/00

(52) U.S. Cl. 174/117 F; 29/825

(57) ABSTRACT

A Z-axis conductive article includes an adhesive layer having a first major surface and a second major surface opposite the first major surface. The adhesive layer includes a dielectric pressure-sensitive adhesive and conductive magnetic particles aligned in mutually isolated conductive pathways extending from the first major surface to the second major surface of the adhesive layer. A method of making the same is also disclosed.

### BACKGROUND

Various conductive articles in the form of tapes and films are used in the manufacture of electronic devices. A conductive article that is conductive through its thickness, but not along its length or width, is generally known as a “Z-axis conductive” article. Z-Axis conductive articles such as, for example, tapes and gaskets may be useful to establish electrical connection(s) between electronic components.

In one type of conventional construction, Z-axis conductivity is achieved by positioning conductive particles to form conductive pathways (i.e., conductive chains) through the thickness of a dielectric matrix in a manner such that they are electrically insulated from one another. Movement of the conductive particles over time can result in discontinuities in the conductive pathways and loss of conductivity.

### SUMMARY

In one aspect, the present disclosure provides a Z-axis conductive article comprising an adhesive layer having a first major surface and a second major surface opposite the first major surface, the adhesive layer having an average thickness, and the adhesive layer comprising a dielectric pressure-sensitive adhesive and conductive magnetic particles aligned in mutually isolated conductive pathways extending from the first major surface to the second major surface of the adhesive layer, wherein the conductive magnetic particles comprise rigid hollow bodies having an average particle diameter that is less than half of the average thickness of the adhesive layer.

In another aspect, the present disclosure provides a method of making a Z-axis conductive article, the method comprising:

disposing a layer of a mixture on a carrier, wherein the mixture comprises a polymerizable composition and conductive magnetic particles, wherein the layer has a first major surface in contact with the carrier and a second major surface opposite the first major surface;

using a magnetic field to align the conductive magnetic particles into mutually isolated conductive pathways extending from the first major surface to the second major surface of the layer of the mixture; and

polymerizing the polymerizable composition under the influence of the magnetic field to form an adhesive layer having first and second opposed major surfaces, the adhesive layer comprising a dielectric pressure-sensitive adhesive and conductive magnetic particles, wherein the conductive magnetic particles are aligned into mutually isolated conductive pathways extending from the first major surface to the second major surface of the adhesive layer.

As used herein, the term “pressure-sensitive” adhesive or “PSA” is defined by the Dahlquist criterion described in Handbook of Pressure-Sensitive Adhesive Technology, D. Satas, 2^{nd} ed., page 172 (1989). This criterion defines a good pressure-sensitive adhesive as one having a one-second creep compliance of greater than 1×10⁻⁶ cm²/dyne at its use temperature (for example, at temperatures in a range of from 15° C. to 35° C.). As a consequence, pressure-sensitive adhesive generally are prone to cold flow, wherein the pressure-sensitive adhesive material, and any fillers contained therein, will flow under ambient conditions. Accordingly, the present inventors' discovery that Z-axis conductive adhesives according to the present disclosure achieve and maintain Z-axis conductivity before and after bonding to substrates is unexpected.

As used herein, the term “(meth)acryl” refers to “acryl” and/or “methacryl”.

As used herein, the term “conductive” means electrically conductive.

The features and advantages of the present disclosure will be further understood upon consideration of the detailed description as well as the appended claims.

### BRIEF DESCRIPTION OF THE DRAWINGS

FIG. 1 is a schematic cross-sectional view of an idealized exemplary Z-axis conductive article 100 according to one embodiment of the present disclosure;

FIG. 2 is a schematic cross-sectional view of an exemplary Z-axis conductive article 200 according to one embodiment of the present disclosure;

While the above-identified drawing figures set forth several embodiments of the present disclosure, other embodiments are also contemplated, as noted in the discussion. In all cases, this disclosure is presented by way of representation and not limitation. It should be understood that numerous other modifications and embodiments can be devised by those skilled in the art, which fall within the scope and spirit of the principles of the disclosure. The figures may not be drawn to scale. Like reference numbers may have been used throughout the figures to denote like parts.

### DETAILED DESCRIPTION

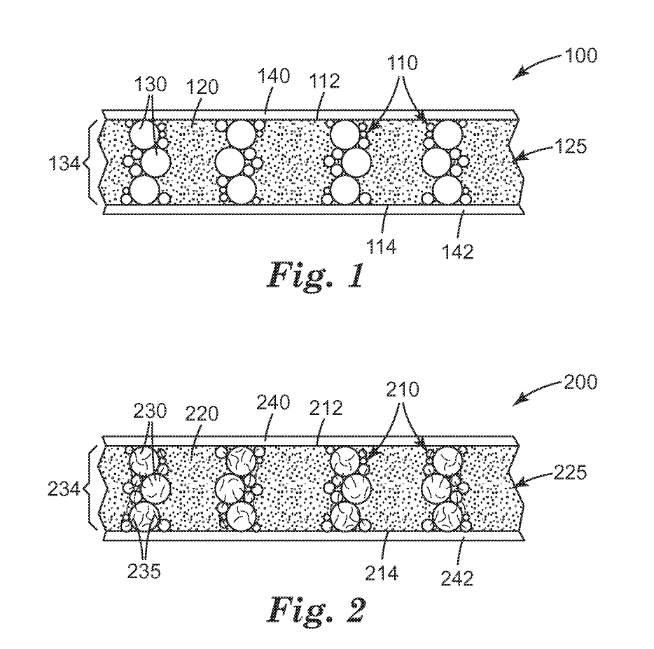

Referring now to FIG. 1, exemplary Z-axis conductive article 100 comprises adhesive layer 125 having a first major surface 112 and a second major surface 114 opposite first major surface 112. Adhesive layer 125 has an average thickness 134. Adhesive layer 125 comprises dielectric pressure-sensitive adhesive 120 and conductive magnetic particles 130 aligned in mutually isolated conductive pathways 110 that extend from first major surface 112 to second major surface 114 of the adhesive layer. Optional first and second releasable liners 140, 142 are disposed on respective first and second major surfaces 112, 114 of adhesive layer 125. Conductive magnetic particles 130 comprise rigid hollow bodies having an average particle diameter that is less than half of the average thickness 134 of the adhesive layer 125.

Z-axis conductive articles according to the present disclosure typically have a thickness in a range of from at least 0.2 mm to 10 mm, more typically from 0.3 mm to 5 mm, however greater and lesser thicknesses may also be used.

If the average particle size of the hollow bodies is larger than half the average thickness of the adhesive layer, then Z-axis conductivity under load may be achieved with a single conductive particle, instead of a plurality of aligned conductive magnetic particles. In such an instance, alignment of the particles is not necessary to achieve Z-axis conductivity. To create isolated conductive channels the conductive magnetic particles are selected such that their average diameter (for example, in the case of hollow bodies or fibers) and preferably length (for example, in the case of fibers) is less than half the average thickness of the adhesive layer. As a result, each of the conductive pathways typically includes a plurality of the electrically conductive magnetic particles.

Any dielectric pressure-sensitive adhesive may be used, as long as there exists a method for orienting the conductive magnetic particles (for example, using a magnetic field) while it (or its precursor) is in a low viscosity state that can be raised to a higher viscosity state. For example, in one embodiment, heating and cooling cycles may be effective to provide mobility within the pressure-sensitive adhesive to orient the conductive magnetic particles (for example, using a magnetic field) which is then locked in place on cooling. In like manner, adhesive compositions useful in the practice of the present disclosure may be extrudable. Similarly, solvent evaporation from a pressure-sensitive adhesive containing solvent may serve to increase viscosity. In one embodiment, a curable adhesive precursor syrup containing conductive magnetic particles is placed in a magnetic field of sufficient strength to orient the conductive magnetic particles, and then they are cured using heat and/or light to form the pressure-sensitive adhesive with conductive pathways therein.

Depending on the mode selected for orienting the magnetic particles, examples of useful pressure-sensitive adhesives include those based on natural rubbers, synthetic rubbers, styrene block copolymers, polyvinyl ethers, acrylics, poly-α-olefins, silicones, polyurethanes, and polyureas.

Useful natural rubber pressure-sensitive adhesives generally contain masticated natural rubber, from 25 parts to 300 parts of one or more tackifying resins to 100 parts of natural rubber, and typically from 0.5 to 2.0 parts of one or more antioxidants per 100 parts of natural rubber. Natural rubber may range in grade from a light pale crepe grade to a darker ribbed smoked sheet and includes such examples as CV-60, a controlled viscosity rubber grade and SMR-5, a ribbed smoked sheet rubber grade.

Tackifying resins used with natural rubbers generally include but are not limited to wood rosin and its hydrogenated derivatives; terpene resins of various softening points, and petroleum-based resins, such as, the ESCOREZ 1300 series of C₅ aliphatic olefin-derived resins from ExxonMobil Chemical, Houston, Tex., and the “PICCOLYTE S” series of polyterpenes from Hercules, Inc. Wilmington, Del. Antioxidants are used to retard the oxidative attack on natural rubber, which can result in loss of the cohesive strength of the natural rubber adhesive. Useful antioxidants include but are not limited to amines, such as N,N′-di-β-naphthyl-1,4-phenylenediamine, available as AGERITE D from R.T. Vanderbilt, Norwalk, Conn.; phenolics such as 2,5-di-(t-amyl)hydroquinone, available as SANTOVAR A from Monsanto Chemical Co., St. Louis, Mo., tetrakis[methylene 3-(3′,5′-di-tert-butyl-4′-hydroxyphenyl)propionate]methane, available as IRGANOX 1010 from Ciba-Geigy Corp., Ardsley, N.Y.; 2,2′-methylene-bis-(4-methyl-6-tert-butylphenol); and dithiocarbamates such as zinc dithiodibutyl carbamate. Other materials can be added to natural rubber adhesives for special purposes, wherein the additions can include plasticizers, pigments, and curing agents to partially vulcanize the pressure-sensitive adhesive.

Another useful class of dielectric pressure-sensitive adhesives is that comprising synthetic rubber. Such adhesives are generally rubbery elastomers, which are either self-tacky or non-tacky and require tackifiers.

Self-tacky synthetic rubber pressure-sensitive adhesives include for example, butyl rubber, a copolymer of isobutylene with less than 3 percent isoprene, polyisobutylene, a homopolymer of isoprene, polybutadiene, or styrene/butadiene rubber. Butyl rubber pressure-sensitive adhesives often contain an antioxidant such as zinc dibutyl dithiocarbamate. Polyisobutylene pressure-sensitive adhesives do not usually contain antioxidants. Synthetic rubber pressure-sensitive adhesives, which generally require tackifiers, are also generally easier to melt process. They comprise polybutadiene or styrene/butadiene rubber, from 10 parts to 200 parts of a tackifier per 100 parts rubber, and generally from 0.5 to 2.0 parts per 100 parts rubber of an antioxidant such as IRGANOX 1010 from BASF, Ludwigshafen, Germany. An example of a synthetic rubber is AMERIPOL 1011A, a styrene/butadiene rubber from Ameripol Synpol, Akron, Ohio. Exemplary tackifiers that are useful include derivatives of rosins such as: FORAL 85, a stabilized rosin ester from Hercules, Inc.; the SNOWTACK series of gum rosins from Tenneco, Lake Forest, Ill.; the AQUATAC series of tall oil rosins from SylvaChem Corp., Memphis, Tenn.; synthetic hydrocarbon resins such as the PICCOLYTE A series, polyterpenes from Hercules, Inc.; the ESCOREZ 1300 series of C₅ aliphatic olefin-derived resins, the ESCOREZ 2000 Series of C₉ aromatic/aliphatic olefin-derived resins, and polyaromatic C₉ resins, such as the PICCO 5000 series of aromatic hydrocarbon resins, from Hercules, Inc. Other materials can be added for special purposes, including hydrogenated butyl rubber, pigments, plasticizers, liquid rubbers, such as VISTANEX LMMH polyisobutylene liquid rubber from ExxonMobil, and curing agents to vulcanize the adhesive partially.

Styrene block copolymer pressure-sensitive adhesives generally comprise elastomers of the A-B or A-B-A type, where A represents a styrenic block and B represents a rubbery block of polyisoprene, polybutadiene, or poly(ethylene/butylene), and resins. Examples of the various block copolymers useful in block copolymer pressure-sensitive adhesives include linear, radial, star and tapered styrene-isoprene block copolymers such as KRATON D1107P, from Shell Chemical Co., Norco, La., and EUROPRENE SOL TE 9110, from EniChem Elastomers Americas, Inc. Houston, Tex.; linear styrene-(ethylene-butylene) block copolymers such as KRATON G1657, from Shell Chemical Co.; linear styrene-(ethylene-propylene) block copolymers such as KRATON G1750X, from Shell Chemical Co.; and linear, radial, and star styrene-butadiene block copolymers such as KRATON D1118X, from Shell Chemical Co., and EUROPRENE SOL TE 6205, from EniChem Elastomers Americas, Inc. The polystyrene blocks tend to form domains in the shape of spheroids, cylinders, or plates that causes the block copolymer pressure-sensitive adhesives to have two-phase structures. Resins that associate with the rubber phase generally develop tack in the pressure-sensitive adhesive. Examples of rubber phase associating resins include aliphatic olefin-derived resins, such as the ESCOREZ 1300 series and the WINGTACK series, from Goodyear Tire and Rubber, Akron, Ohio; rosin esters, such as the FORAL series and the STAYBELITE Ester 10, both from Hercules, Inc.; hydrogenated hydrocarbons, such as the ESCOREZ 5000 series, from ExxonMobil; polyterpenes, such as the PICCOLYTE A series; and terpene phenolic resins derived from petroleum or turpentine sources, such as PICCOFYN A100, from Hercules, Inc. Resins that associate with the styrenic phase tend to stiffen the pressure-sensitive adhesive. Styrenic phase associating resins include polyaromatics, such as the PICCO 6000 series of aromatic hydrocarbon resins, from Hercules, Inc.; coumarone-indene resins, such as the CUMAR series, from Neville, Pittsburgh, Pa.; and other high-solubility parameter resins derived from coal tar or petroleum and having softening points above about 85° C. such as PICCOVAR 130 alkyl aromatic polyindene resin, from Hercules, Inc., and the PICCOTEX series of α-methylstyrene/vinyl toluene resins, from Hercules. Other materials can be added for special purposes, including rubber phase plasticizing hydrocarbon oils available as TUFFLO 6056 from Lydondell Chemical Co., Houston, Tex., as POLYBUTENE-8 from Chevron Corp., San Ramon, Calif., as KAYDOL, from Chemtura, Philadelphia, Pa., and as SHELLFLEX 371 from Shell Chemical Co.; pigments; antioxidants, such as IRGANOX 1010 and IRGANOX 1076, both from Ciba-Geigy Corp., BUTAZATE, from Uniroyal Chemical Co., Middlebury, Conn., CYANOX LDTP from Cytec Industries, Woodland Park, New Jersey, and BUTASAN, from Monsanto Co.; antiozonants such as NBC, a nickel dibutyl dithiocarbamate, from E.I. du Pont de Nemours & Co., Wilmington, Del.; liquid rubbers such as VISTANEX LMMH polyisobutylene rubber; and ultraviolet light inhibitors, such as IRGANOX 1010 and TINUVIN P, from Ciba-Geigy Corp.

Polyvinyl ether pressure-sensitive adhesives are generally blends of homopolymers of vinyl methyl ether, vinyl ethyl ether or vinyl isobutyl ether, or blends of homopolymers of vinyl ethers and copolymers of vinyl ethers and acrylates to achieve preferred pressure-sensitive properties. Depending on the degree of polymerization, homopolymers may be viscous oils, tacky soft resins or rubber-like substances. Polyvinyl ethers used as raw materials in polyvinyl ether adhesives include polymers based on: vinyl methyl ether, such as LUTANOL M 40, from BASF, and GANTREZ M 574 and GANTREZ 555, from ISP Corp. Wayne, N.J.; vinyl ethyl ether, such as LUTANOL A 25, LUTANOL A 50 and LUTANOL A 100; vinyl isobutyl ether such as LUTANOL 130, LUTANOL 160, LUTANOL IC, LUTANOL 160D and LUTANOL 165D; methacrylate/vinyl isobutyl ether/acrylic acid such as ACRONAL 550 D, from BASF. Antioxidants useful to stabilize polyvinyl ether pressure-sensitive adhesives include, for example, IONOX 30 from Shell Chemical Corp., and IRGANOX 1010 from Ciba-Geigy Corp. Other materials can be added for special purposes as described in BASF literature including tackifier, plasticizer and pigments.

Poly-α-olefin pressure-sensitive adhesives, also called a poly(1-alkene) pressure-sensitive adhesives, generally comprise either a substantially non-crosslinked polymer or a non-crosslinked polymer that may have radiation activatable functional groups grafted thereon as described in U.S. Pat. No. 5,209,971 (Babu, et al.). The poly(α-olefin) polymer may be self-tacky and/or include one or more tackifying materials. If non-crosslinked, the inherent viscosity of the polymer is generally between about 0.7 and 5.0 dL/g as measured by ASTM D 2857-93, “Standard Practice for Dilute Solution Viscosity of Polymers.” In addition, the polymer generally is predominantly amorphous. Useful poly-α-olefin polymers include, for example, C₃-C₁₈ poly(α-olefin) polymers, preferably C₅-C₁₂ α-olefins and copolymers of those with C₃ and more preferably C₆-C₈ and copolymers of those with C₃. Tackifying materials are typically resins that are miscible in the poly-α-olefin polymer. The total amount of tackifying resin in the poly-α-olefin polymer ranges between 0 to 150 parts by weight per 100 parts of the poly-α-olefin polymer depending on the specific application. Useful tackifying resins include, for example, resins derived by polymerization of C₅ to C₉ unsaturated hydrocarbon monomers, polyterpenes, and synthetic polyterpenes. Examples of such commercially available resins based on a C₅ olefin fraction of this type are WINGTACK 95 and WINGTACK 15 tackifying resins from Goodyear Tire and Rubber Co. Other hydrocarbon resins include REGALREZ 1078 and REGALREZ 1126 from Hercules Chemical Co., and ARKON P115 from Arakawa Chemical Co., Chicago, Ill. Other materials can be added for special purposes, including antioxidants, fillers, pigments, and radiation activated crosslinking agents.

Silicone pressure-sensitive adhesives comprise two major components, a polymer or gum, and a tackifying resin. The polymer is typically a high molecular weight polydimethylsiloxane or poly(dimethyl diphenyl siloxane), that contains residual silanol functionality (SiOH) on the ends of the polymer chain, or a block copolymer comprising polydiorganosiloxane soft segments and urea terminated hard segments. The tackifying resin is generally a three-dimensional silicate structure that is endcapped with trimethylsiloxy (—OSi(CH₃)₃) groups and also contains some residual silanol functionality. Examples of tackifying resins include SR 545, from General Electric Co., Silicone Resins Division, Waterford, N.Y., and MQD-32-2 from Shin-Etsu Silicones of America, Inc., Torrance, Calif. Manufacture of typical silicone pressure-sensitive adhesives is described in U.S. Pat. No. 2,736,721 (Dexter). Manufacture of silicone urea block copolymer pressure-sensitive adhesive is described in U.S. Pat. No. 5,214,119 (Leir, et al.). Other materials can be added for special purposes, including, pigments, plasticizers, and fillers. Fillers are typically used in amounts from 0 parts to 10 parts per 100 parts of silicone pressure-sensitive adhesive.

Acrylic pressure-sensitive adhesives generally have a glass transition temperature of about −20° C. or less and may comprise from 100 to 80 weight percent of a C₃-C₁₂ alkyl ester component such as, for example, isooctyl acrylate, 2-ethylhexyl acrylate and n-butyl acrylate and from 0 to 20 weight percent of a polar component such as, for example, acrylic acid, methacrylic acid, ethylene vinyl acetate, N-vinylpyrrolidone, and styrene macromer. Preferably, acrylic pressure-sensitive adhesives comprise from 0 to 20 weight percent of acrylic acid and from 100 to 80 weight percent of isooctyl acrylate.

Acrylic pressure-sensitive adhesives may be self-tacky or tackified. Useful tackifiers for acrylics are rosin esters such as FORAL 85, from Hercules, Inc., aromatic resins such as PICCOTEX LC-55WK, aliphatic resins such as PICCOTAC 95, from Hercules, Inc., and terpene resins such as a-pinene and 13-pinene, available as PICCOLYTE A-115 and ZONAREZ B-100 from Arizona Chemical, Phoenix, Ariz. Other materials can be added for special purposes, including hydrogenated butyl rubber, pigments, and curing agents to vulcanize the adhesive partially.

Acrylic pressure-sensitive adhesives can be prepared by prepolymerizing a mixture of polymerizable monomers containing a thermal and/or photoinitiator to form a coatable syrup, coating the coatable syrup, and further polymerizing the coated syrup. Typically, the mixture of polymerizable monomers comprises 50-100 parts by weight of at least one acrylic acid ester of an alkyl alcohol (preferably a non-tertiary alcohol), the alcohol containing from 1 to 14 (preferably 4 to 14) carbon atoms. Included within this class of monomers are, for example, isooctyl acrylate, isononyl acrylate, 2-ethylhexyl acrylate, decyl acrylate, dodecyl acrylate, n-butyl acrylate, methyl acrylate, and hexyl acrylate. Preferred monomers include, for example, isooctyl acrylate, isononyl acrylate, butyl acrylate, and 2-ethylhexyl acrylate.

The acrylic acid ester (“acrylate”) is copolymerized with 0 to 50 parts of at least one copolymerizable monomer which is typically an ethylenically unsaturated polar monomer such as, for example, acrylic acid, methacrylic acid, acrylamide, acrylonitrile, methacrylonitrile, N-substituted acrylamides, hydroxyacrylates, N-vinyllactam, N-vinylpyrrolidone, maleic anhydride, isobornyl acrylate, and itaconic acid.

Exemplary photoinitiators include benzoin ethers such as benzoin methyl ether and benzoin isopropyl ether; substituted phosphine oxides such as 2,4,6-trimethylbenzoyldiphenylphosphine oxide available as LUCIRIN TPO-L from BASF; substituted acetophenones such as 2,2-diethoxyacetophenone, available as IRGACURE 651 photoinitiator from Ciba-Geigy Corp.; 2,2-dimethoxy-2-phenyl-1-phenylethanone, available as ESACURE KB-1 photoinitiator from Sartomer Co., West Chester, Pa.; and dimethoxyhydroxyacetophenone; substituted α-ketols such as 2-methyl-2-hydroxypropiophenone, 2-naphthalenesulfonyl chloride, and 1-phenyl-1,2-propanedione-2-(O-ethoxycarbonyl)oxime. Particularly useful are the substituted acetophenones or 2,4,6-trimethylbenzoyldiphenylphosphine oxide. Preferably, the photoinitiator is present in an amount of from about 0.01 part to about 5 parts by weight, and most preferably, about 0.10 to 2 parts by weight, based upon 100 total parts by weight of monomer.

Prepolymerization can be accomplished by exposure to electromagnetic radiation (such as UV light) or by thermal polymerization. Other methods of increasing the viscosity of the monomer mixture are also available, however, such as the addition of viscosity modifying agents such as, for example, high molecular weight polymers or thixotropic agents such as colloidal silicas. A syrup is a monomeric mixture thickened to a coatable viscosity.

The polymerizable monomer mixture preferably contains a crosslinking agent to enhance the cohesive strength of the resulting adhesive or article. Useful crosslinking agents which also function as photoinitiators are the chromophore-substituted halomethyl-s-triazines disclosed in U.S. Pat. Nos. 4,330,590 (Vesley) and 4,329,384 (Vesley et al.). Other suitable crosslinking agents include hydrogen abstracting carbonyls such as anthraquinone and benzophenone and their derivatives, as disclosed in U.S. Pat. No. 4,181,752 (Martens et al.), and polyfunctional acrylates such as, for example, 1,6-hexanediol diacrylate, trimethylolpropane triacrylate, and 1,2-ethylene glycol diacrylate, as well as those disclosed in U.S. Pat. No. 4,379,201 (Heilmann et al.).

The polymerizable mixture of monomers or prepolymerized syrup can be coated onto any suitable substrate including, for example, releasable liners, films (transparent and non-transparent), cloths, papers, non-woven fibrous constructions, metal foils, and aligned filaments.

Afterwards, the mixture of monomers or partially prepolymerized syrup is photopolymerized by irradiating the same with actinic radiation (for example, electromagnetic radiation of 280 to 500 nanometer wavelength and 0.01 to 20 milliwatts per square centimeter (mW/cm²) average light intensity) to affect about 5 to 95 percent conversion of the monomeric mixture or prepolymerized syrup to form a pressure-sensitive adhesive.

Irradiation is preferably carried out in the absence of oxygen. Thus, it is normally carried out in an inert atmosphere such as nitrogen, carbon dioxide, helium, argon, and the like. Air can also be excluded by sandwiching the liquid polymerizable mixture between layers of solid sheet material and irradiating through the sheet material. As will be appreciated by those skilled in the art, such material can have low adhesion surfaces and can be removed after polymerization is complete or one such surface can be a tape backing material. Preferably, the stages of irradiation are conducted continuously, or in-line without interruption of the polymerization process, i.e., the coated mixture is exposed to the first stage irradiation (pre-polymerization) and then immediately exposed to the second stage irradiation (polymerization) with no interruption of the inert atmosphere between the stages.

If desired, the coatable syrup may include a blowing agent and/or be frothed (for example, mechanically or using compressed gas); for example to lower the density of the resultant Z-axis conductive adhesive.

Other materials which can be blended with the polymerizable monomer mixture include fillers, tackifiers, foaming agents, antioxidants, plasticizers, reinforcing agents, dyes, pigments, fibers, fire retardants, and viscosity adjusting agents.

The magnetic conductive particles and optional magnetic conductive fibers may be dispersed within the adhesive matrix at any stage of this process prior to coating and curing. For example, the magnetic conductive particles may be dispersed in the monomer mixture, in the monomer mixture with added modifying agent or in the coatable syrup. For ease of dispersal, the magnetic conductive particles (and optional magnetic conductive fibers) are typically added to the monomer mixture or the coatable syrup.

At least some of the magnetic conductive particles are hollow, but solid particles may also be used. The magnetic conductive particles may have uniform composition throughout, or they may be composite particles. Composite particles may, for example, have one or more conductive and/or magnetic layers surrounding a core. Examples of suitable magnetic conductive particles include iron particles, ferritic particles, nickel particles, cobalt particles, glass or polymeric microspheres (hollow or solid) having a coating of ferritic material, nickel, or cobalt thereon, optionally overcoated with a layer of conductive material such as, for example, silver, gold, or an alloy comprising silver or gold. Typical magnetic conductive particle diameters are in a range from 0.1 to 500 micrometers, and preferably in a range from 1 to 200 micrometers, although other diameters can be used.

The magnetic conductive particles are typically included in the adhesive layer in an amount of from 25 to 50 percent by volume, based on the total volume of the adhesive layer, preferably from 31 to 41 percent by volume, based on the total volume of the adhesive layer, although other amounts may also be used. In the case of silver-coated stainless steel-clad K15 SCOTCHLITE glass bubbles (e.g., Silver-Coated Magnetic Coated Glass Bubbles (AG/SS Bubbles) used in the Examples hereinbelow) coated glass bubbles from 3M Company, Saint Paul, Minn., the magnetic conductive particles are typically included in the adhesive layer in an amount of from 8 to 20 percent by weight, based on the total weight of the adhesive layer, preferably from 10 to 15 percent by weight, based on the total weight of the adhesive layer, although other amounts may also be used.

The optional magnetic conductive fibers may be, for example, solid or hollow, and may have uniform composition throughout, or they may be composite fibers. Composite fibers may, for example, have one or more conductive and/or magnetic sheath layers surrounding a core. Examples of suitable magnetic conductive fibers include ferritic fibers (e.g., silver-clad stainless steel-coated glass fibers, steel fibers), nickel fibers, cobalt fibers, glass or polymeric fibers having a coating of ferritic material, nickel, or cobalt thereon, optionally overcoated with a layer of conductive material such as, for example, silver, gold, or an alloy comprising silver or gold. Typical magnetic conductive fiber diameters are in a range from 5 to 25 micrometers, and preferably in a range from 10 to 20 micrometers, although other lengths can be used. Typical magnetic conductive fiber lengths are in a range from 50 to 1000 micrometers, and preferably in a range from 100 to 500 micrometers, although other lengths can be used.

The magnetic conductive fibers, if present, are typically included in the adhesive layer in an amount of from 1 to 10 percent by weight based on the total weight of the adhesive layer, preferably from 3 to 6 percent by weight, although other amounts may also be used.

Magnetic and/or conductive coatings may be applied to particles and fibers using any suitable method. In the case of metallic coatings, sputter coating methods and thermal vapor coating methods may be useful. Such methods are known to those of skill in the art.

Magnetic field strengths suitable for particle alignment depend on adhesive layer thickness and viscosity, greater field strength being advantageous for thicker layers. Typical field strengths are in a range from 100 to 2000 oersteds, and more typically in a range from 300 to 800 oersteds.

Referring now to FIG. 2, Z-axis conductive article 200 comprises adhesive layer 225, a first major surface 212 and a second major surface 214 opposite first major surface 212. Adhesive layer 225 has an average thickness 234. Adhesive layer 225 comprises dielectric pressure-sensitive adhesive 220, and conductive magnetic hollow microspheres 230 and conductive fibers 235 which are aligned in the adhesive layer 220 into mutually isolated conductive pathways 210 that extend from first major surface 212 to second major surface 214. Optional first and second releasable liners 240, 242 are disposed on respective first and second major surfaces 212, 214 of adhesive layer 225.

Suitable releasable liners include, for example, polymer-coated paper with a silicone release coating, polyethylene-coated polyethylene terephthalate (PET) film with a silicone release coating, and cast polypropylene film with a silicone release coating. The liner may have a single-sided or double-sided release coating thereon.

Z-axis conductive articles according to the present disclosure are useful, for example, as Z-axis conductive tapes.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Vapor Deposition Apparatus

The vapor deposition apparatus used in the following examples was as that described in FIGS. 2 and 3, and paragraphs [0109]-[0111] of U.S. Patent Appl. Publ. 2005/0095189 A1 (Brey et al.), which description is incorporated herein by reference, except that the metal sputter target was 5 in wide×8 in long and 0.5 in thick (13 cm×20 cm×1.3 cm), the particle agitator was a hollow cylinder (9.5 in (24 cm) long×7.5 in (19 cm) inner diameter) with a rectangular opening (6.5 in×5.3 in, (17 cm×13 cm)) in the top.

### Measurement of Electrical Conductivity of Coated Particles

The powder volume resistivity of coated particles was measured using the following procedure. The test cell consisted of a DELRIN thermoplastic block containing a cylindrical cavity with circular cross section of 1.0 cm². The bottom of the cavity was covered by a brass electrode. The other electrode was a 1.0 cm² cross section brass cylinder which was fitted into the cavity. The powder to be tested was placed in the cavity, and then the brass cylinder was inserted. A weight was placed on top of the brass cylinder to exert a total pressure of 18 psi (120 kPa) on the powder. The electrodes were connected to a digital multimeter to measure resistance. When the powder bed was compacted by tapping the cylinder to 1.0 cm in thickness the observed resistance was equivalent to the powder resistivity.

### Preparation of Magnetic Coated Glass Bubbles (SS Bubbles)

K15 SCOTCHLITE glass bubbles (2000 cm³, 300 g, particle size distribution (10 percent less than 30 microns, 50 percent less than 60 microns, 90 percent less than 105 microns), from 3M Company, Saint Paul, Minn.) were dried for 6 hours at 150° C. in a convection oven. The dried particles were placed into the Vapor Deposition Apparatus, and the chamber was then evacuated. Once the chamber pressure was in the 10⁻⁵ torr (1 mPa) range, argon sputtering gas was admitted to the chamber at a pressure of about 10 millitorr (1 Pa). Type 304 stainless steel metal was used as the sputter target. The deposition process was then started by applying a cathodic power of 2.00 kilowatts. The particle agitator shaft was rotated at about 4 rpm during the deposition process. The power was stopped after 24 hours. The chamber was backfilled with air and the stainless steel coated particles were removed from the apparatus. The coated particles were tested for magnetic response by measuring the inductance at 100 kHz with an LCR meter. An LCR meter is a hand-held device capable of measuring inductance (L), capacitance (C), or resistance (R) when attached to an appropriate sensing device. The sensing device is a solenoid coil prepared by winding insulated copper wire (gage size 36, 0.127 mm diameter) onto a 19.0 mm outer diameter glass tube. The coil had 333 turns in four layers over a length of 3.0 cm. The 2 leads from the sensing coil were connected to a digital LCR meter (Fluke, model # PM6306, D-22145 Hamburg, Germany). An 80 mm long, 16 mm outer diameter glass tube was filled with the stainless steel coated particles and inserted into the sensing glass tube. An inductance value of 10 microhenries was obtained after subtracting the background value of the empty glass tube.

The 304 stainless steel sputter target had a non-magnetic austenitic face centered cubic structure, but deposited as a magnetic ferritic body with centered cubic structure. These materials have been described by Barbee et al. in Thin Solid Films, 1979, vol. 63, pp. 143-150.

### Preparation of Silver-Coated Magnetic Coated Glass Bubbles (AG/SS Bubbles)

Silver was coated onto SS Bubbles using the same vapor deposition apparatus and method as above, except that a silver target was DC magnetron sputtered onto the SS Bubbles at 0.40 kW for 20 hours at an argon sputter gas pressure of 5 millitorr (0.6 Pa). After 20 hours, the silver coated particles were removed from the particle agitator. The powder electrical resistivity was measured as described above using a cylindrical powder holder and a multimeter. The resistivity of the coated particles was less than 1 ohm-cm.

### Preparation of Silver-Stainless Steel Coated Glass Fibers (AG/SS Fibers)

The procedures for preparation of SS Bubbles and AG/SS Bubbles (above) were repeated, except that milled glass fibers were used in place of the glass bubbles. The milled glass fibers were purchased as MICROGLASS 3016 milled glass fiber from Fibertec, Bridgewater, Mass. The average fiber diameter was 10 microns, with a length of 140 microns. Typical aspect ratio was 13:1.

The resistivity value for the coated glass fibers was 0.1 ohm-cm.

### Comparative Examples A-G and Examples 1-4

Mixtures of 95 parts per hundred weight (pph) of 2-ethylhexyl acrylate, 5 pph of acrylic acid, 0.23 pph of 2,2-dimethoxy-2-phenylacetophenone, 0.055 pph of hexanediol diacrylate, 1.5 pph of silica particles (available as AS H15 silica from Wacker Chemie, Munich, Germany), and particles of the type and quantity described in TABLE 1, were prepared and partially polymerized, generally according to the method of U.S. Pat. No. 4,330,590 (Vesley), to yield syrups of coatable viscosity.

The resulting syrups were thoroughly and slowly mixed with a mechanical stirrer, and fed to the nip of a knife coater between a pair of transparent polyethylene terephthalate release liners. The knife coater was adjusted to provide coating thickness of 20 mils (0.51 mm). The composite emerging from the roll coater was passed between two banks of lamps with a total UVA dosage of 1800 mJ/cm². For some of the examples, a magnetic field of 1000 oersteds was applied in the region just before, and spaced intermittently with, the lamps in the curing zone. Compositions and applied magnetic field strengths are reported in Table 1 (below).

TABLE 1

| | AMOUNT | | | |
|---|---|---|---|---|
| | OF 3M | | | |
| | SCOTCHLITE | AMOUNT | AMOUNT | MAG- |
| | K15 GLASS | OF AG/SS | OF AG/SS | NETIC |
| | BUBBLES, | BUBBLES, | FIBERS, | DOSAGE, |
| EXAMPLE | pph | pph | pph | oersteds |
| COMPARATIVE | 8 | 0 | 0 | 0 |
| EXAMPLE A | | | | |
| COMPARATIVE | 8 | 0 | 5 | 0 |
| EXAMPLE B | | | | |
| COMPARATIVE | 0 | 8 | 0 | 0 |
| EXAMPLE C | | | | |
| COMPARATIVE | 0 | 12 | 0 | 0 |
| EXAMPLE D | | | | |
| COMPARATIVE | 0 | 8 | 5 | 0 |
| EXAMPLE E | | | | |
| COMPARATIVE | 0 | 12 | 5 | 0 |
| EXAMPLE F | | | | |
| COMPARATIVE | 8 | 0 | 0 | 1000 |
| EXAMPLE G | | | | |
| 1 | 0 | 8 | 0 | 1000 |
| 2 | 0 | 12 | 0 | 1000 |
| 3 | 8 | 0 | 5 | 1000 |
| 4 | 0 | 12 | 5 | 1000 |

### Z-Direction Contact Force Resistance Measurement

The electric resistance of the Comparative Examples and Examples was measured according to the following general procedure:

A 1 inch×1 inch (2.5 cm×2.5 cm) specimen to be tested was placed between two horizontally-mounted conductive contact blocks (each with an area of 1 inch×1 inch (2.5 cm×2.5 cm)). A weight (as indicated in Table 2) was applied to the upper block. Electrical resistance was measured with a multimeter.

### Electrical Resistance Measurement (XY-Direction)

X-Y plane resistivity of the following samples was measured with a Fluke digital multimeter. Two strips of rectangular metal electrodes with a height of 3 cm and gap between the electrodes of 0.3 cm were placed directly on the sample.

Results are reported in TABLE 2 (below).

TABLE 2

| | | | | | | X-Y | THICKNESS, |
|---|---|---|---|---|---|---|---|
| | Z-DIRECTION CONTACT FORCE RESISTIVITY, ohms | | | | | RESISTIVITY, | mils |
| EXAMPLE | 0.5 kg | 1 kg | 1.5 kg | 2.5 kg | 4.5 kg | ohms | (microns) |
| COMP. EX. A | ≧20000 | ≧20000 | ≧20000 | ≧20000 | ≧20000 | | 20 (510) |
| COMP. EX. B | ≧20000 | ≧20000 | ≧20000 | ≧20000 | ≧20000 | ≧30 × 10⁶ | 20 (510) |
| COMP. EX. C | ≧20000 | ≧20000 | ≧20000 | ≧20000 | ≧20000 | ≧30 × 10⁶ | 20 (510) |
| COMP. EX. D | ≧20000 | 13000 | 6500 | 4020 | 710 | ≧30 × 10⁶ | 20 (510) |
| COMP. EX. E | ≧20000 | ≧20000 | ≧20000 | ≧20000 | ≧20000 | ≧30 × 10⁶ | 20 (510) |
| COMP. EX. F | 964 | 524 | 285 | 216 | 110 | 4000-7000 | 20 (510) |
| COMP. EX. G | ≧20000 | ≧20000 | ≧20000 | ≧20000 | ≧20000 | ≧30 × 10⁶ | 20 (510) |
| 1 | 416 | 287 | 185 | 104 | 65 | ≧30 × 10⁶ | 20 (510) |
| 2 | 16 | 15.5 | 12.5 | 8.8 | 5.6 | ≧30 × 10⁶ | 20 (510) |
| 3 | 0.41 | 0.36 | 0.342 | 0.26 | 0.255 | ≧30 × 10⁶ | 20 (510) |
| 4 | 0.96 | 0.88 | 0.68 | 0.47 | 0.46 | ≧30 × 10⁶ | 20 (510) |

### Select Embodiments of the Present Disclosure

In a first embodiment, the present disclosure provides a Z-axis conductive article comprising an adhesive layer having a first major surface and a second major surface opposite the first major surface, the adhesive layer having an average thickness, and the adhesive layer comprising a dielectric pressure-sensitive adhesive and conductive magnetic particles aligned in mutually isolated conductive pathways extending from the first major surface to the second major surface of the adhesive layer, wherein the conductive magnetic particles comprise hollow bodies having an average particle diameter that is less than half of the average thickness of the adhesive layer.

In a second embodiment, the present disclosure provides a Z-axis conductive article according to the first embodiment, wherein each of the hollow bodies has a conductive magnetic layer disposed thereon.

In a third embodiment, the present disclosure provides a Z-axis conductive article according to the first or second embodiment, wherein the hollow bodies comprise hollow glass microspheres.

In a fourth embodiment, the present disclosure provides a Z-axis conductive article according to any one of first to third embodiments, wherein the conductive magnetic particles comprise a layer of conductive metal disposed on a layer of magnetic material.

In a fifth embodiment, the present disclosure provides a Z-axis conductive article according to any one of first to fourth embodiments, wherein the conductive magnetic particles further comprise conductive magnetic fibers.

In a sixth embodiment, the present disclosure provides a Z-axis conductive article according to any one of first to fifth embodiments, wherein the dielectric pressure-sensitive adhesive comprises a crosslinked acrylic polymer.

In a seventh embodiment, the present disclosure provides a Z-axis conductive article according to any one of first to sixth embodiments, further comprising a releasable liner disposed on the first major surface of the adhesive layer.

In an eighth embodiment, the present disclosure provides a Z-axis conductive article according to any one of first to seventh embodiments, further comprising a releasable liner disposed on the second major surface of the adhesive layer.

In a ninth embodiment, the present disclosure provides a Z-axis conductive article according to any one of first to eighth embodiments, wherein the conductive magnetic particles comprise 25 to 50 percent by volume of the total volume of the adhesive layer.

In a tenth embodiment, the present disclosure provides a method of making a Z-axis conductive article, the method comprising:

disposing a layer of a mixture on a carrier, wherein the mixture comprises a polymerizable composition and conductive magnetic particles, wherein the layer has a first major surface in contact with the carrier and a second major surface opposite the first major surface;

using a magnetic field to align the conductive magnetic particles into mutually isolated conductive pathways extending from the first major surface to the second major surface of the layer of the mixture; and

polymerizing the polymerizable composition under the influence of the magnetic field to form an adhesive layer having first and second opposed major surfaces, the adhesive layer comprising a dielectric pressure-sensitive adhesive and conductive magnetic particles, wherein the conductive magnetic particles are aligned into mutually isolated conductive pathways extending from the first major surface to the second major surface of the adhesive layer.

In an eleventh embodiment, the present disclosure provides a method according to the tenth embodiment, wherein said polymerizing the polymerizable composition comprises photopolymerizing, and wherein the polymerizable composition comprises: an acrylic free-radically polymerizable compound, and a free-radical photoinitiator.

In a twelfth embodiment, the present disclosure provides a method according to the tenth or eleventh embodiment, further comprising at least one of foaming or frothing the mixture prior to applying it to the carrier.

In a thirteenth embodiment, the present disclosure provides a method according to any one of the tenth to twelfth embodiments, wherein the conductive magnetic particles comprise 4 to 15 percent by weight, based and the total weight of the adhesive layer.

In a fourteenth embodiment, the present disclosure provides a method according to any one of the tenth to thirteenth embodiments, wherein the carrier is transmissive to actinic radiation capable of decomposing at least a portion of the free-radical photoinitiator.

In a fifteenth embodiment, the present disclosure provides a method according to any one of the tenth to fourteenth embodiments, further comprising removing the Z-axis conductive article from the carrier.

Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A Z-axis conductive article comprising an adhesive layer having a first major surface and a second major surface opposite the first major surface, the adhesive layer having an average thickness, and the adhesive layer comprising a dielectric pressure-sensitive adhesive and conductive magnetic particles aligned in mutually isolated conductive pathways extending from the first major surface to the second major surface of the adhesive layer, wherein the conductive magnetic particles comprise rigid hollow bodies having an average particle diameter that is less than half of the average thickness of the adhesive layer.

2. The Z-axis conductive article of claim 1, wherein each of the hollow bodies has a conductive magnetic layer disposed thereon.

3. The Z-axis conductive article of claim 1, wherein the hollow bodies comprise hollow glass microspheres.

4. The Z-axis conductive article of claim 1, wherein the conductive magnetic particles comprise a layer of conductive metal disposed on a layer of magnetic material.

5. The Z-axis conductive article of claim 1, wherein the conductive magnetic particles further comprise conductive magnetic fibers.

6. The Z-axis conductive article of claim 1, wherein the dielectric pressure-sensitive adhesive comprises a crosslinked acrylic polymer.

7. The Z-axis conductive article of claim 1, further comprising a releasable liner disposed on the first major surface of the adhesive layer.

8. The Z-axis conductive article of claim 7, further comprising a releasable liner disposed on the second major surface of the adhesive layer.

9. The Z-axis conductive article of claim 7, wherein the conductive magnetic particles comprise 25 to 50 percent by volume of the total volume of the adhesive layer.

10. A method of making a Z-axis conductive article, the method comprising:
disposing a layer of a mixture on a carrier, wherein the mixture comprises a polymerizable composition and conductive magnetic particles, wherein the layer has a first major surface in contact with the carrier and a second major surface opposite the first major surface;
using a magnetic field to align the conductive magnetic particles into mutually isolated conductive pathways extending from the first major surface to the second major surface of the layer of the mixture; and
polymerizing the polymerizable composition under the influence of the magnetic field to form an adhesive layer having first and second opposed major surfaces, the adhesive layer comprising a dielectric pressure-sensitive adhesive and conductive magnetic particles, wherein the conductive magnetic particles are aligned into mutually isolated conductive pathways extending from the first major surface to the second major surface of the adhesive layer.

11. The method of claim 10, wherein said polymerizing the polymerizable composition comprises photopolymerizing, and wherein the polymerizable composition comprises: an acrylic free-radically polymerizable compound, and a free-radical photoinitiator.

12. The method of claim 10, further comprising at least one of foaming or frothing the mixture prior to applying it to the carrier.

13. The method of claim 10, wherein the conductive magnetic particles comprise 4 to 15 percent by weight, based and the total weight of the adhesive layer.

14. The method of claim 10, wherein the carrier is transmissive to actinic radiation capable of decomposing at least a portion of the free-radical photoinitiator.

15. The method of claim 10, further comprising removing the Z-axis conductive article from the carrier.
